(19) United States
(12) Patent Application Publication
(10) Pub. No.: US 2003/0190092 A1
(43) Pub. Date: Oct. 9, 2003

(54) System and method for resizing a digital image

(76) Inventors: Robert M. Dyas, Naperville, IL (US); Mark A. Timko, Burr Ridge, IL (US)

Correspondence Address: MOTOROLA, INC., 1303 EAST ALGONQUIN ROAD, IL01/3RD, SCHAUMBURG, IL, 60196

(21) Appl. No.: 10/431,734

(22) Filed: May 8, 2003

Related U.S. Application Data
(62) Division of application No. 09/521,405, filed on Mar. 8, 2000.

(51) Int. Cl. G06K 9/32

(52) U.S. Cl. 382/298

(57) ABSTRACT

A system and method for resizing an original image into a resized image is provided. The system processes the luminance channel and the chrominance channels (C_{b} and Cᵣ) of the original image separately. The original image is divided into original sub-blocks of appropriate size. Each original sub-block may be processed into a corresponding resized sub-block. Only the luminance and chrominance data from one of the original sub-blocks may be used to create a corresponding resized sub-block, thus no overlap techniques need be employed. The system and method resizes the original sub-blocks into the resized sub-blocks without the use of multipliers.

### BACKGROUND OF THE INVENTION

The present invention relates to a system and method for relatively quickly and efficiently resizing digital images.

Traditional methods for resizing a digital image is to separate the process into two discreet procedures. The first procedure involves resizing the original image in the horizontal, or x-axis, dimension only to form an intermediate image. The second procedure involves resizing the intermediate image in the vertical, or y-axis, dimension only to form the resized image. Each resizing procedure is performed on all three channels (a luminance (Y) channel and two chrominance (C_{b} and Cᵣ) channels) of the original image.

Unfortunately, this method requires that two finite-impulse-response (FIR) filters be employed on all channels of the image. Numerous problems or concerns arise in such a method. For example, the FIR filters must be of a relatively high order to maintain acceptable quality. The FIR filters also require memory space to store coefficients. Large buffers are needed to maintain the intermediate image. In addition, multipliers are needed to implement the filter. Multipliers implemented by software are typically slow and multipliers implemented in hardware are relatively expensive.

Other methods for resizing digital images split an original image into a number of sub-blocks. The sub-blocks are then reduced in size and recombined to form the resized image. In these methods, the sub-blocks are split into a center portion, a horizontal overlap portion and a vertical overlap portion. Generally the horizontal and vertical overlap portions are single rows or single columns which are common to two adjacent sub-blocks. Disadvantageously, this method also uses two FIR filters and filters all three channels of the image. In addition, the overlap portions need to be processed and stored in a relatively large buffer before reassembling into the resized sub-blocks.

There is thus a need in the art for a system and method for resizing digital images which is less complex than prior methods and which can be implemented at a relatively low cost while providing an acceptable quality.

### BRIEF DESCRIPTION OF THE DRAWINGS

The foregoing and other advantages of the invention will become apparent upon reading the following detailed description and upon reference to the drawings in which:

FIG. 1 is a block diagram of a system for resizing an original image into a resized image in accordance with the present invention;

FIG. 1A is a detailed view of the original image and the resized image as shown in FIG. 1;

FIG. 2 is a block diagram of a luminance circuit for resampling luminance information in the original image into the resized image;

FIG. 3 is a block diagram of a chrominance circuit 300 for resampling chromanince information in the original image into the resized image;

FIG. 4 is an graphical representation of a sub-block showing the luminance and chrominance information;

FIG. 5 shows four matrices of luminance information which are used by the luminance circuit shown in FIG. 2;

FIG. 6 shows the sub-block as shown in FIG. 4 and illustrates the construction of the matrices shown in FIG. 5;

FIG. 7 shows an exemplary hardware implementation of a luma address sequencer in the luminance circuit shown in FIG. 2;

FIG. 8 shows a matrix of chrominance information which is used by the chrominance circuit shown in FIG. 3;

FIGS. 9 and 10 show the respective chroma (Cb) resampling and chroma (Cr) resampling on the sub-block as shown in FIG. 4; and

FIG. 11 shows an exemplary hardware implementation of a chroma address sequencer in the chrominance circuit shown in FIG. 2.

### DETAILED DESCRIPTION OF THE PREFERRED EMBODIMENTS

In accordance with one aspect of the present invention a system and method for resizing an original image into a resized image is provided. A luminance circuit processes original luma data relating to the original image to form resized luma data for the resized image. A chrominance circuit processes original chroma data relating to the original image to form resized chroma data for the resized image. The resized image is then generated based on the resized luma and chroma data. The luminance circuit may be a filter, such as a FIR filter. The chrominance circuit may be comprised of a first interpolator for interpolating original chroma data relating to Cᵣ chroma data; and a second interpolator for interpolating original chroma data relating to a C_{b} chroma data.

In accordance with another aspect of the present invention, a method is provided for resizing an original image into a resized image. The original image is divided into original sub-blocks having original borders. The size of the original sub-blocks is then changed to form resized sub-blocks having resized borders based directly on the original borders. The resized sub-blocks are then combined to form the resized image.

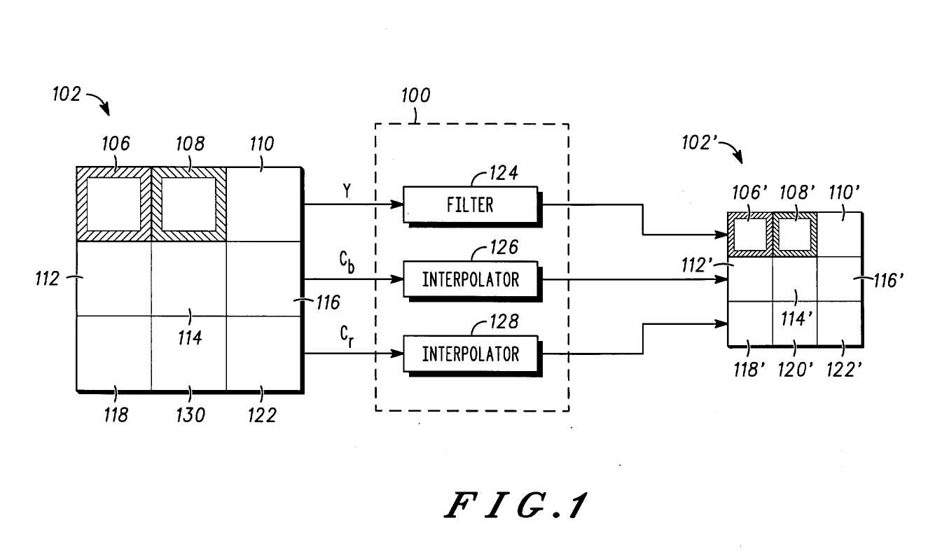

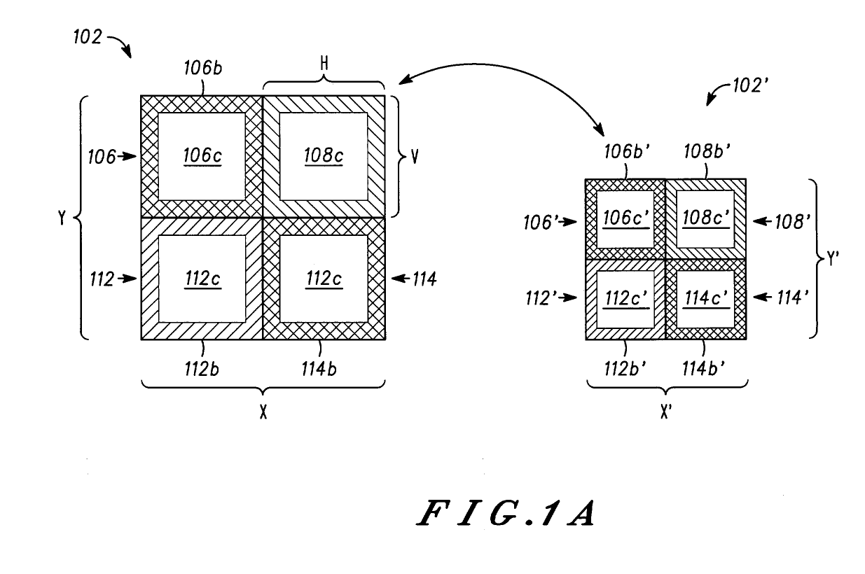

In accordance with the present invention, a system 100 for resizing an original image 102 into a resized image 102′ in accordance with the present invention is shown FIG. 1. The original image 102 is initially divided into original sub-blocks 106 through 122. It should be appreciated that although the original image 102 is shown divided into nine original sub-blocks, the actual number of the original sub-blocks is not restricted to nine and may be changed depending upon the particular application.

The system 100 resizes each of the original sub-blocks 106 through 122 into corresponding resized sub-blocks 106a through 122a. As is known in the art, the original image 102 can be defined by a luminance channel Y and two chrominance channels C_{b} and Cᵣ. For each of the original sub-blocks 106 through 122, each of the three channels Y, C_{b} and Cᵣ are processed by the system 100. The luminance channel Y is processed by luminance circuit, shown as a filter 124 which may be a FIR filter. Advantageously, in accordance with the present invention, the filter 124 operates only on the luminance channel Y and not on the chrominance channels C_{b} and Cᵣ, as in prior devices. Consequently, the lumaninance circuit, or the filter 124, of the present invention may be less complex and of a lesser order than in the prior devices.

First and second chrominance circuits, shown as first and second interpolators 126, and 128, which preferably perform zero order interpolations, operate on the respective chrominance channels C_{b} and Cᵣ. It should be appreciated that the first and second interpolators 126 and 128 may be implemented in one or more hardware devices or by the appropriate software. Advantageously, since the chrominance channels C_{b} and Cᵣ are selected from the original image 102 without filtering, the introduction of false colors into the resized image 102′ is avoided or diminished.

With reference to FIG. 1A, a close up view of the original sub-blocks 106, 108, 112 and 114 and their corresponding resized sub-blocks 106a, 108a, 112a and 114a is provided. Each of the original sub-blocks 106, 108, 112 and 114 has a respective original border 106b, 108b, 112b and 114b and original center 106c, 108c, 112c and 114c. Similarly, the resized sub-blocks 106a, 108a, 112a and 114a have respective resized borders 106b′, 108b′, 112b′ and 114b′ and resized centers 106c′, 108c′, 112c′ and 114c′. As will be described more fully below, the system 100 advantageously directly uses pixels of original borders 106b, 108b, 112b and 114b to form their corresponding resized borders 106b′, 108b′, 112b′ and 114b′.

In accordance with one aspect of the invention, as is more fully described below, the original centers 106c, 108c, 112c and 114c are resized using a reduced complexity interpolation which may, for example, consist of simple averaging of four nearest pixel neighbors. By using such an averaging of nearest neighbors to generate the pixels forming the resized image 102, acceptable quality can be obtained with a relatively uncomplex process and results in lower cost hardware required for implementation. A further advantageous aspect of the invention is that zero order interpolation is used on the original borders 106b, 108b, 112b and 114b. Such use of zero order interpolation assures that adjacent pixels in the resized image 104 were adjacent in the original image 102. Having this continuity reduces the possibility of edge artifacts from the block processing.

A method in accordance with one aspect of the present invention will now be described with reference to FIG. 1A. The original image 102 is shown having a horizontal dimension X and a vertical dimension Y. Using these dimensions X and Y, a resizing operation in accordance with an aspect of the present invention may be specified by an integer decimation factor Q and an integer interpolation factor P. These factors will have values for both the horizontal, or x-axis, (Q_{X} and P_{X}) and the vertical, or y-axis (Q_{Y} and P_{Y}). In general, the x-axis factors Q_{X} and P_{X} may have values different from their corresponding y-axis factors Q_{Y} and P_{Y}.

The resized image 102 ′ will have the following dimensions: horizontal dimension X′=X*(P_{X}/Q_{X}) and vertical dimension Y′=Y*(P_{Y}/Q_{Y}). As those skilled in the art will readily appreciate, the size and the number of sub-blocks should be chosen based on the specific application, such as the size of the original image and the desired size of the resized image. Based on this application specific information of the size and number of sub-blocks, a horizontal sub-block dimension H and a vertical sub-block dimension V are specified. Typically, for images having a YC_{b}Cᵣ ratio of 4:4:4, the horizontal and vertical sub-block dimensions H and V are chosen such that the horizontal dimension X is an integer multiple of the horizontal sub-block dimension H and the vertical dimension Y is an integer multiple of the vertical sub-block dimension V.

For images having a YC_{b}Cᵣ ratio of 4:2:2, the vertical dimension Y is typically an integer multiple of twice the vertical sub-block dimension 2*V due to the horizontal decimation of the chrominance channels C_{b} and Cᵣ. For 4:2:0 YC_{b}Cᵣ images, the horizontal dimension X is an integer multiple of twice the horizontal sub-block dimension 2*H and the vertical dimension Y is an integer multiple of twice the vertical sub-block dimension 2*V due to the horizontal and vertical decimation of the chrominance channels C_{b} and Cᵣ.

Luminance and chrominance dimensions (in both horizontal and vertical directions) of the resized sub-block 102 ′ can be computed as follows:

Resized horizontal luminance sub-block dimension H_{RY}=H*P_{X}/Q_{X}.

Resized vertical luminance sub-block dimension V_{RY}=V*P_{Y}/Q_{Y}.

Resized horizontal chrominance sub-block dimension H_{RC}=(H_{C}*P_{X}/Q_{X}), where H_{C}=H for 4:4:4 YC_{b}Cᵣ, images and H_{C}=H/2 for 4:2:2 and 4:2:0 YC_{b}Cᵣ images.

Resized vertical chrominance sub-block dimension V_{RC}=V_{C}*P_{Y}/Q_{Y}, where V_{C}=V for 4:4:4 and 4:2:2 images and V_{C}=V/2 for 4:2:0 images.

Six index vectors used to determine pixel index addresses in the resized sub-blocks are determined as follows:

L(n)=floor((n*(H−1))/H_{RY}) for n=0, 1, 2, . . . H_{RY}−1.

R(n)=ceil((n*(H−1))/H_{RY}) for n=0, 1, 2, . . . H_{RY}−1.

U(n)=floor((n*(V−1))/V_{RY}) for n=0, 1, 2, . . . V_{RY}−1.

D(n)=ceil((n*(V−1))/V_{RY}) for n=0, 1, 2, . . . V_{RY}−1.

C_{H}(n)=round((n*(H_{C}−1))/H_{RC}) for n=0, 1, 2, . . . H_{RC}−1.

Cᵥ(n)=round((n*(V_{C}−1))/V_{RC}) for n=0, 1, 2, . . . V_{RC}−1.

wherein:

I=floor(x) is defined as the closest integer I≦x.

I=ceil(x) is defined as the closest integer I≧x.

I=round(x) is defined as I=floor(x+0.5).

The index vectors are computed once at the beginning of the resizing operation, or procedure. The following psuedo-code represents exemplary operations which may be performed on each sub-block. Matrices used in the psuedo-code are defined as follows:

YO—the luminance of the original sub-block.

RO—the Cᵣ chrominance of the original sub-block.

CO—the C_{b} chrominance of the original sub-block.

YR—the luminance of the resized sub-block.

RR—the Cᵣ chrominance of the resized sub-block.

CR—the C_{b} chrominance of the resized sub-block.

The exemplary psuedo-code is as follows:

for I = 0 to H_{Ry} − 1

for j = to V_{RY} − 1
//Compute interpolated luminance value
YR(j,i) = (YO(L(i), U(j)) + YO(L(i), D(j)) +

YO(R(i), U(j)) + YO(R(i), D(j))) < <2;

//Compute interpolated chrominance values
RR(j,i) = RO(C_{H}(i), RO(Cᵥ(j));
CR(j,i) = CO(C_{H}(i), CO(Cᵥ(j));

end

Those skilled in the art will readily appreciate that the above index vectors are constructed so that the boundaries of the sub-blocks are not treated different as far as the psuedo-code is concerned. Additionally, if P_{X}=Q_{X} and P_{Y}=Q_{Y}, the exemplary method results in the resized image 102′ being exactly the same as the original image 102.

It should be appreciated that the disclosed implementation, and in particular the disclosed formulas, are only one of various possible implementations and formulas which will be apparent to those skilled in the art with the benefit of this disclosure. For example, modification of the address sequences may result in perceptually better quality.

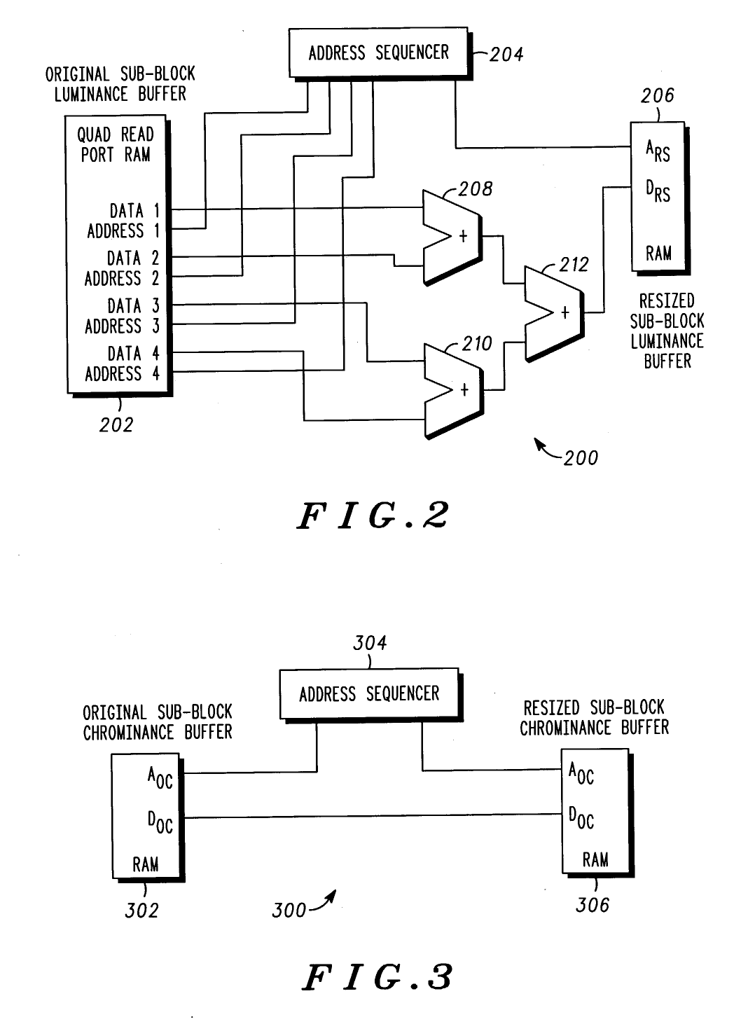

In accordance with another aspect of the invention, an exemplary hardware implementation will now be described with reference to FIGS. 2 through 10. An address sequencer is programmed to generate the six pixel index addresses, as discussed above. For clarity and ease of description, the structure, control and arrangement of the conventional components and circuits have, for the most part, been illustrated in the drawings by readily understandable block representations and schematic diagrams, which show only those specific details that are pertinent to the present invention. These block representations and schematic diagrams have been employed in order not to obscure the disclosure with structural details which will be readily apparent to those skilled in the art having the benefit of the description herein.

Referring now to FIG. 2, a block diagram of an exemplary implementation of a luminance circuit 200, such as may be implemented as the filter 124, is shown. An original sub-block luminance buffer 202, which is shown for example to be a quad read port random access memory (RAM), stores luminance information, or data, in a lookup memory for translating pixel information received from a luma address sequencer 204 into four initial luma data values Data1, Data2, Data3 and Data4. It should be noted that the four initial luma data values Data1, Data2, Data3 and Data4 are shown for exemplary purposes only and may include more or less data values. Advantageously, the luminance circuit 200, and in particular the original sub-block luminance buffer 202, allows for arbitrary values of the pixel index addresses to be programmed. For improved performance, pixel index addresses for edge pixels should not be modified to include points located interior to the border. If such modification occurs, there is a likelihood that block artifacts may become more visible.

The original sub-block luminance buffer 202 contains inputs for first, second, third and fourth original pixel index addresses Address1, Address2, Address3 and Address4 . The luma address sequencer 204 provides these inputs to the original sub-block luminance buffer 202 based on the original pixel luminance values, as describe more fully below. The original sub-block luminance buffer 202 generates four luma initial data values Data1, Data2, Data3 and Data4 based on the received values of the original pixel index addresses Address1, Address2, Address3 and Address4.

The luma address sequencer 204 receives actual original pixel luma values for the original sub-blocks, processes these original pixel luma values and produces the original pixel index addresses Address1, Address2, Address3 and Address4 which are sent to the buffer 202. The luma address sequencer 204 further provides a resized pixel index address A_{RS}, based on the equations and steps set forth above, to a resized sub-block luminance buffer 206.

The first and second initial luma data values Data1 and Data2 are added by a first adder 208 to produce a first intermediate pixel luma data value. Similarly, the third and fourth initial luma data values Data3 and Data4 are added by a second adder 210 to produce a second intermediate luma data value. The first and second intermediate luma data values are combined (added) by a third adder 212 to form a resized pixel luma data value D_{RS}. First, second and third adders 208, 210 and 212 comprise an adder circuit. Advantageously, in accordance with one aspect of the present invention, the luminance value is resized separately from the chrominance values, thus reducing the size of the buffer memory required as compared to prior system which apply FIR filters to each of the luminance and two chrominance channels. In addition, the exemplary luminance circuit 200 comprises three adders 208, 210 and 212 and does not employ multipliers which are complex and relatively expensive, as in prior systems.

Referring now to FIG. 3, a block diagram of an exemplary implementation of a chrominance circuit 300, which may be advantageously employed as one or both of the first and second interpolators 126 and 128, is shown. Thus, although the following description will be directed to general chrominance information, or data, it should be appreciated that it applies equally to the chrominance channel C_{b} and the chrominance channel Cᵣ. An original sub-block chrominance buffer 302 stores a look up table for translating the chrominance data values of the original image 102 into chrominance data values for the resized image 102′. A chroma address sequencer 304 receives actual chroma pixel data of the original sub-blocks and generates a chroma pixel index address A_{OC}. The original sub-block chrominance buffer 302 uses its look up table to translate the pixel index address A_{OC} into a resized pixel chroma data value D_{OC} which is sent to resized sub-block chrominance buffer 306. Those skilled in the art will readily appreciate that although the various components of the circuits 200 and 300 are shown in different drawings, like components may be shared between the two circuits 200 and 300. For example, the address sequencers 204 and 304 may be provided in a single component.

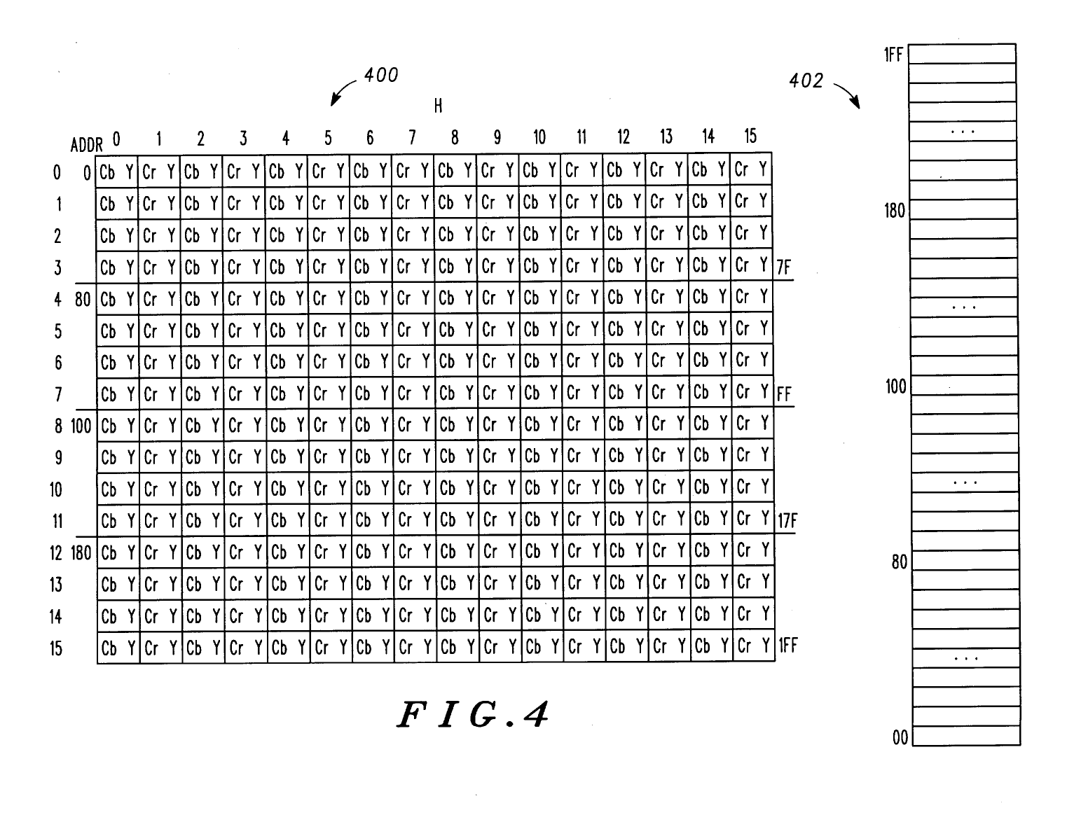

In accordance with yet another aspect of the invention, the address sequencers 204 and 304 have a unique and compact implementation which will be described with reference to FIGS. 4 through 10. Each address sequencer 204 and 304 is implemented based on the observation that the binary values of the pixel index addresses may be combined to form address sequences into a buffer of interleaved data using a very regular control structure of counters.

The implementation to be described assumes that the data being resized is a 16×16 block of 4:2:2 YCᵣC_{b} pixels, or data, that are stored in a buffer in an interleaved format. The interleaved format is assumed to be C_{b}, Y, Cᵣ, Y, C_{b}, Y, Cᵣ, Y, . . . An original sub-block buffer memory map, or a resizer input buffer memory map, in tabular form 400 and column form 402 is shown having the aforedescribed interleaved format. Each sequence value consists of four (4) bits. The pairings of the 4 bit sequence values can be best exemplified by using an example of resizing a 16×16 original block of pixels into a 5×5 resized block of pixels. Since the buffer is storing 4:2:2 YCᵣC_{b} data, the Cᵣ and C_{b} components are only 8×16 blocks (horizontally decimated). The difference between the 16×16 block of the luminance Y component and the 8×16 blocks of the chrominance Cᵣ and C_{b} components will necessitate that the address sequences for the luminance Y component be generated in a different manner than the chrominance Cᵣ and C_{b} components. Consequently, the luminance values Y and the chrominance values Cᵣ and C_{b} will be discussed separately.

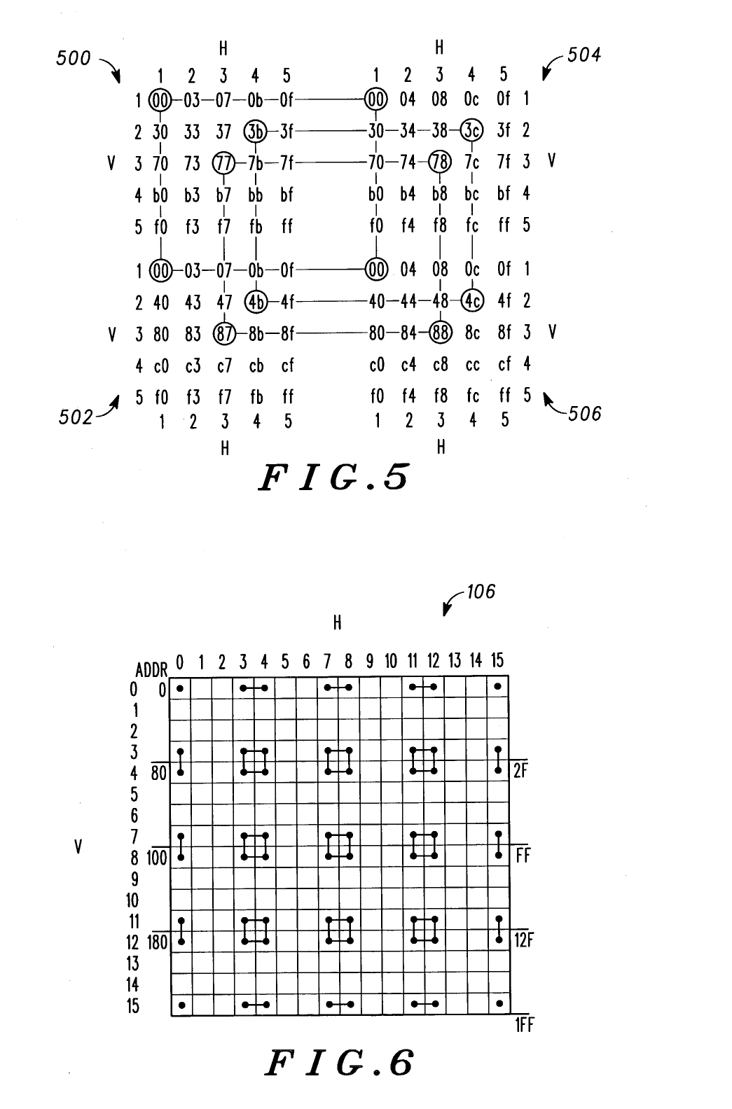

First, the generation of an address sequence for the luminance values Y will be discussed. The luminance value Y resampling is shown in FIGS. 5 and 6 for a value of N=5. FIG. 5 shows first, second, third and fourth address matrices 500, 502, 504 and 506 having five rows and five columns of original pixel addresses. The first address matrix 500 represents the addresses for the upper left corner pixel used in the averaging sample. Based on FIG. 5, it can be determined that luma_{—}1=0 3 7 b f and luma_{—}2=0 4 8 c f. The luma_{—}1 and luma_{—}2 are the two 1×N matrices that are crossed in four possible combinations (1×1, 1×2, 2×1 and 2×2) to form the four N×N address matrices 500, 502, 504 and 506. By examining the four address matrices 500, 502, 504 and 506 of addresses, it can be seen that the first address matrix 500 is created by crossing the luma_{—}1 sequence with itself.

As the rows in the first address matrix 500 are traversed, the low four bits of the first address matrix 500 are equal to the luma_{—}1 sequence. As the columns of the first address matrix 500 are traversed, the high four bits of the address are the same as the luma_{—}1 sequence. The fourth address matrix 506 is generated by crossing the luma_{—}2 sequence with itself, in a manner similar to that described above with respect to the first address matrix 500. The third address matrix 504 is generated by using the luma_{—}2 sequence for the low four bits of the address in each row and using the luma_{—}1 sequence for the high four bits of the address in each column. The second address matrix 502 differs from the third address matrix 504 in that the luma_{—}1 sequence is used for the low four bits in the rows and the luma_{—}2 sequence is used for the high four bits in the columns.

An address sequence for the luma resampling process is generated by stepping through all four address matrices 500, 502, 504 and 506 starting with the upper left address of each address matrix 500, 502, 504 and 506. The first address in each address matrix 500, 502, 504 and 506 represents the four pixel values that will be averaged together to form an upper right, or first, luma pixel of the 5×5 resized block. To generate a second luma pixel of the 5×5 resized block, the second address in the first row of each address matrix 500, 502, 504 and 506 is used to read the data out. This continues for each row in the address matrices 500, 502, 504 and 506.

Since this example assumes that the YCᵣC_{b} values in the original sub-block lumanince buffer 202 are interleaved, the eight bit addresses in each of the four address matrices 500, 502, 504 and 506 need to have a “1” appended before the least significant bit (LSB) to map each address into a physical memory. As shown in FIG. 4, the Y values are stored on odd addresses. The luma interpolation for one of the original sub-blocks 106 having the vertical dimension V and the horizontal dimension H and sub-divided into 15 vertical pixel addresses and 15 horizontal pixel addresses is shown in FIG. 6.

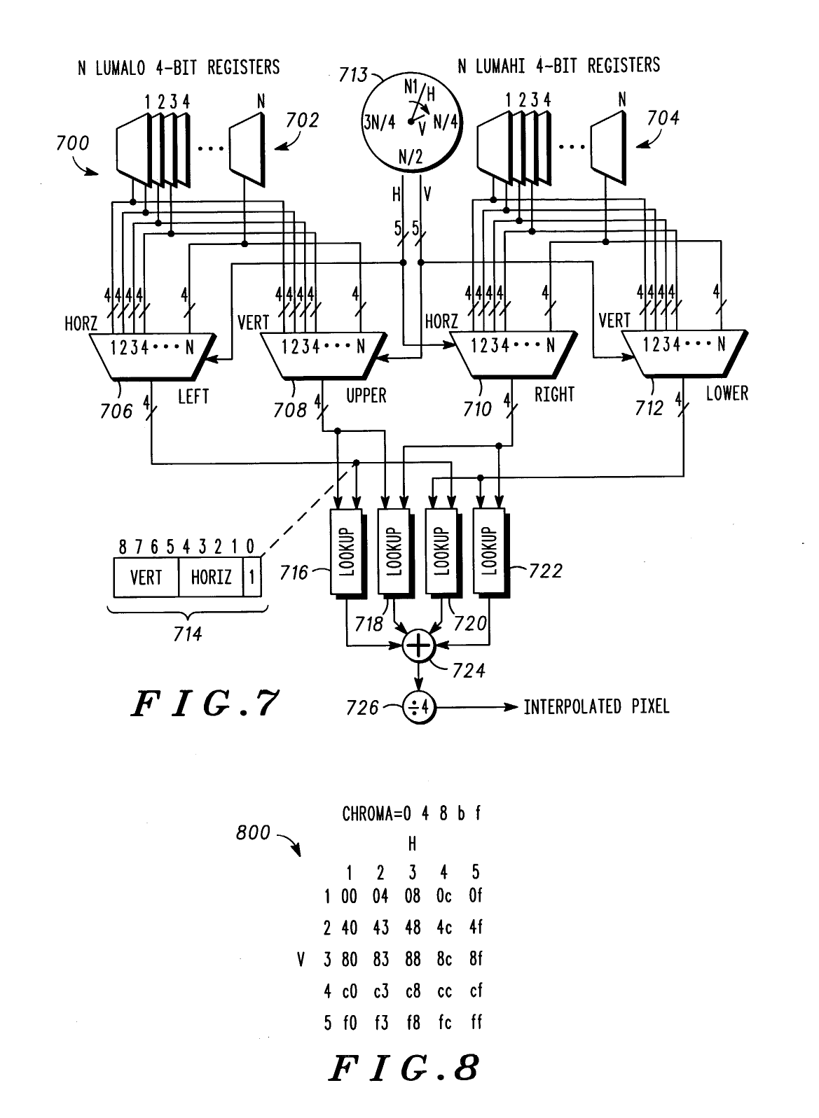

A graphical representation of an exemplary implementation 700 of the luma address sequencer 204 in accordance with another aspect of the invention is shown in FIG. 7. Advantageously, this implementation requires only first and second sets of 32×4 bit registers 702 and 704, each of which have 1−N registers, to store the luma_{—}1 and luma_{—}2gh sequences. First and second sets of registers 702 and 704 drive respective first and second sets of 32:1 multiplexers (MUXs) 706, 708 and 710, 712 which select the proper 4 bit lookup value from each address sequence received from the registers 702 and 704.

The lookup values from the four MUXs are paired and appended with a “1” on the LSB to create four physical addresses for the resized luma values in a lookup RAM in the original buffer 202. Control of the MUXs 706, 708, 710 and 712 may be performed by a simple set of horizontal and vertical counters, illustrated by counter 713, that are set up to count up to N (5 in the example). Both the horizontal and vertical counters are initialized to zero. The horizontal counter is incremented after four values have been read out of the original sub-block buffer 202 which would be the first output pixel of the 5×5 resized block. The vertical counter is incremented every time the horizontal counter reaches N. After reaching N, the horizontal counter is reset to start the next row.

The physical addresses are formed from a 4-bit output from a vertical MUX, such as MUX 708 or 712, and a 4-bit output from a horizontal MUX, such as MUX 706 or 710. An example of such a physical address with an appended “1” on the LSB is shown at reference numeral 714. The lookup process for each of the four physical addresses are illustrated by first, second, third and fourth lookup block 716, 718, 720 and 722. Since four lookup processes need to take place for the four physical addresses, the processes need to be time-interleaved.

The four lookup blocks 716, 718, 720 and 722 result in respective pixel luma values pixel0, pixel1, pixel2 and pixel3. The pixel luma values pixel0, pixel1, pixel2 and pixel3 represent an upper left pixel, an upper right pixel, a lower left pixel and a lower right pixel, respectively. The pixel luma values pixel0, pixel1, pixel2 and pixel3 are added by adder 724 and divided by four via a divider 726 to produce a interpolated luma pixel to be sent to the resized sub-block luminance buffer 206.

Advantageously, the adder 724 may be implemented as an accumulator since the pixel values are interleaved. Further, the divider 726 may be implemented using a right shift by 2 bits. This is advantageous since hardware dividers are relatively costly.

Chroma (Cᵣ and C_{b}) resampling will now be discussed with reference to FIGS. 8, 9, 10 and 11. Those skilled in the art will readily appreciate that the chroma resampling is very similar to the above described luma resampling, except there is no averaging performed (zero order filter). Thus, there is only one chroma matrix 800 used to generate the original chroma addresses for the Cᵣ and C_{b} values that are directly sampled. Since the image is 4:2:2 YCᵣC_{d}, each of the 16×16 blocks of the luminance Y component has associated 16×8 blocks of the chrominance Cᵣ and C_{b} components. Therefore, in this instance, the address sequencer (or addresses sequencer since there are two chrominance components (Cᵣ and C_{b}) generates addresses for Cr or Cb values in two separate 8×16 blocks that are then spread across two input buffers.

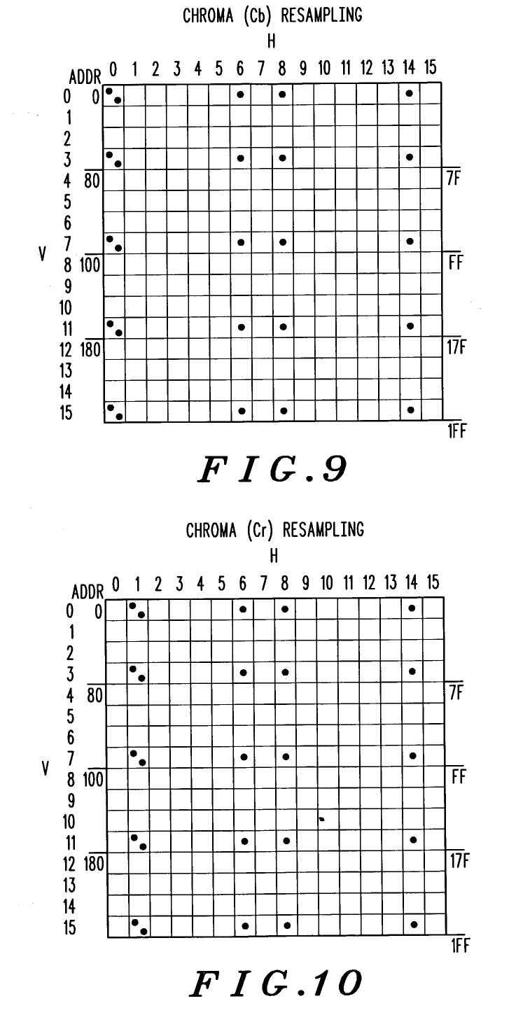

The chroma address sequencer 304 operates as if it is processing a single 16×16 block which is divided into first and second halves. The chroma resampling process for N=5 is shown in FIGS. 8, 9 and 10. In FIG. 8, the chroma sequences span two blocks: an even block and an odd block. In FIGS. 9 and 10, even blocks are represented by large dots and odd blocks are represented by small dots.

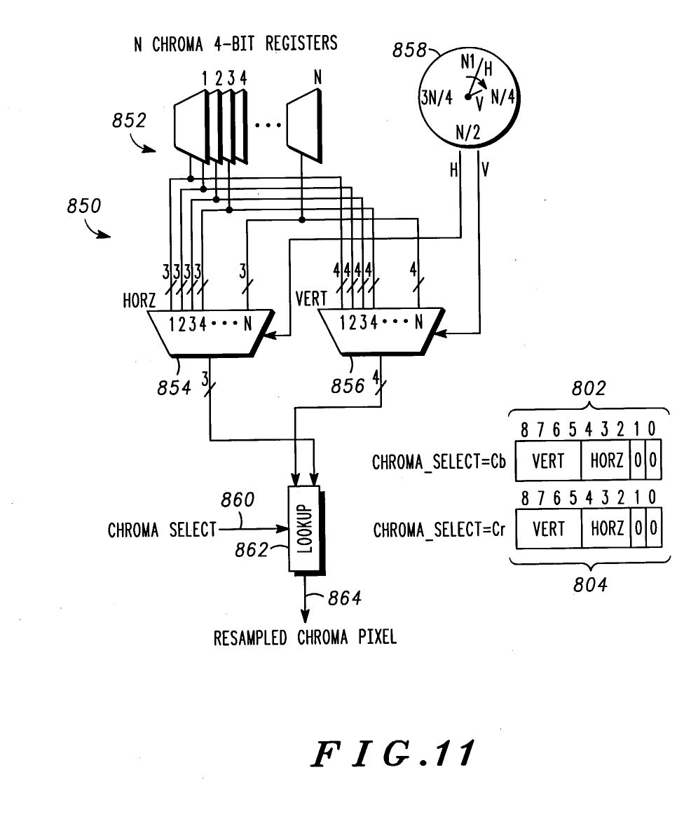

The pairing of the 4 bit chroma sequence values is similar to the pairing of the luma sequence values discussed above. To map the pixel addresses to physical addresses in the original sub-block chrominance buffer 302 and process the two halves of of the 16×16 chroma input (the two 16×8 chroma matrices), the upper bit of the low four bit value in the pixel address is removed. This limits the low four bit values to between 0 and 7 which maps to the 8×16 chroma blocks. The upper four bit value is used in the same manner as in the luma address sequencer 204. To handle the interleaved data with the Cᵣ and C_{b} values occurring every fourth pixel, a “00” is appended before the LSB for a calculated physical address 802 for the chroma C_{b} and a “10” is appended before the LSB for a calculated physical address 804 for the chroma Cᵣ , as shown in FIG. 11.

The following Table 1 shows the addresses for the first output row of the 5×5 block. The first two rows of the table are addresses in the first 8×16 block of chroma and the last three rows are addresses in the second 8×16 block of chroma.

TABLE 1

| | | C_{b} addr | C_{b} pixel | Cᵣ Addr | Cᵣ pixel |
|---|---|---|---|---|---|
| Constant | 3 Isb's | (hex) | (dec) | (hex) | (dec) |
| 0 | 000 | 00 | 0 | 02 | 1 |
| 4 | 100 | 10 | 8 | 12 | 9 |
| 8 | 000 | 00 | 0 | 02 | 1 |
| B | 011 | 0C | 6 | 0E | 7 |
| F | 111 | 1C | 14 | 1E | 15 |

A graphical representation of an exemplary implementation 850 of the chroma address sequencer 304 in accordance with yet another aspect of the present invention is shown in FIG. 11. A set {1, 2, 3, 4, . . . N} of 32×4 bit registers 852 store chroma sequences. The registers 852 drive first, or horizontal, and second, or vertical, 32:1 multiplexers (MUXs) 854 and 856 which select the proper bit value from each address sequence.

The outputs of the two MUXs 854 and 856 are paired and, as noted above, if relating to chroma C_{b}, appended with a “00” and, if relating to chroma Cᵣ , appended with a “10”, to create a physical address to retrieve the appropriate (Cr or Cb) pixel data from a lookup RAM in the original sub-block chrominance buffer 302. Addresses are formed from a four bit output from the vertical MUX 856 and a three bit output from the horizontal MUX 854, as shown in the addresses 802 and 804. The chroma address sequencer 304 uses vertical and horizontal counters, shown as reference numeral 858, in a manner substantially similar to that described above with respect to the luma address sequencer 204. However, for the chrominance address sequencer 304, the horizontal counter must reset and trigger the vertical counter at N/2 (rounded down) for the first 8×16 block. For the second 8×16 block, the vertical counter must start at N/2 (rounded up) and reset and trigger at N. The particular chroma selected is shown in the drawing by input 860.

Depending upon which chroma Cr or Cb has been selected, a lookup 862 is performed for either of the addresses 802 or 804. Based on the results of the lookup 862, a resampled chroma pixel 864 is produced and sent to the resized sub-block chromanince buffer 306. After all the lumanince Y values and all the chrominance Cr and Cb values have been resampled, the resized image 102′ is reconstructed.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modification, equivalents and alternatives falling within the spirit and scope of the invention as defined by the following appended claims.

What is claimed is:

1. A system for resizing an original image into a resized image comprising:
a luminance circuit for processing original luma data relating to the original image to form resized luma data for the resized image; and
a chrominance circuit for processing original chroma data relating to the original image to form resized chroma data for the resized image.

2. The system as recited in claim 1 wherein the luminance circuit comprises a filter.

3. The system as recited in claim 2 wherein the filter is a finite-impulse-response filter.

4. The system as recited in claim 1 wherein the chrominance circuit comprises:
an interpolator for interpolating the original chroma data.

5. The system as recited in claim 4 wherein the interpolator performs a zero order interpolation on the original chroma data.

6. The system as recited in claim 1 wherein the chrominance circuit comprises:
a first interpolator for interpolating original chroma data relating to Cᵣ chroma data, and
a second interpolator for interpolating original chroma data relating to a C_{b} chroma data.

7. The system as recited in claim 6 wherein the first interpolator performs a zero order interpolation on the original chroma data relating to Cᵣ chroma data.

8. The system as recited in claim 6 wherein the second interpolator performs a zero order interpolation on the original chroma data relating to C_{b} chroma data.

9. The system as recited in claim 1 wherein the luminance circuit comprises:
an original luminance buffer for storing the original luma data including original pixel luma data and original pixel addresses,
a luma address sequencer for receiving the original pixel addresses and for translating the original pixel addresses into resized pixel addresses, and
an adder circuit for processing the original pixel luma data to create a resized pixel luma data, and
a resized sub-block luminance buffer for storing the resized pixel addresses and the resized pixel luma data.

10. The system as recited in claim 9 wherein the luma address sequencer comprises:
a set of registers for receiving luma pixel data for the original sub-blocks and for generating luma pixel addresses, and
one or more multiplexers for multiplexing the luma pixel addresses to form lookup values which are used to determine the original pixel luma data.

11. The system as recited in claim 1 wherein the chrominance circuit comprises:
a chroma address sequencer for generating a chroma pixel index addresses based on the chroma data of the original image, and
an original sub-block chrominance buffer for receiving the chroma pixel index addresses and for generating resized pixel chroma data values based on the chroma pixel index addresses.

12. A system for resizing an original image comprised of original sub-blocks into a resized image comprised of resized sub-blocks, the system processing data from only one of the original sub-blocks to form a corresponding one of the resized sub-blocks.

13. The system as recited in claim 12 comprising:
a luminance circuit for processing an original luminance channel of the one of the original sub-blocks to generate a resized luminance channel for the corresponding resized sub-block, and
a chrominance circuit for processing an original chrominance channel of the one of the original sub-blocks to generate a resized chrominance channel for the corresponding resized sub-block.

14. The system as recited in claim 13 wherein the luminance circuit comprises a filter.

15. The system as recited in claim 14 wherein the filter is a finite-impulse-response filter.

16. The system as recited in claim 13 wherein the chrominance circuit comprises an interpolator for interpolating the original chroma data.

17. The system as recited in claim 16 wherein the interpolator performs a zero order interpolation on the original chroma data.

18. The system as recited in claim 13 wherein the chrominance circuit comprises:
a first interpolator for interpolating original chroma data relating to Cᵣ chroma data, and
a second interpolator for interpolating original chroma data relating to a C_{b} chroma data.

19. The system as recited in claim 18 wherein the first interpolator performs a zero order interpolation on the original chroma data relating to Cᵣ chroma data.

20. The system as recited in claim 18 wherein the second interpolator performs a zero order interpolation on the original chroma data relating to C_{b} chroma data.

21. The system as recited in claim 16 wherein the luminance circuit comprises:
an original luminance buffer for storing the original luma data including original pixel luma data and original pixel addresses,
a luma address sequencer for receiving the original pixel addresses and for translating the original pixel addresses into resized pixel addresses, and
an adder circuit for processing the original pixel luma data to create a resized pixel luma data, and
a resized sub-block luminance buffer for storing the resized pixel addresses and the resized pixel luma data.

22. The system as recited in claim 21 wherein the luma address sequencer comprises:
a set of registers for receiving luma pixel data for the original sub-blocks and for generating luma pixel addresse,; and
one or more multiplexers for multiplexing the luma pixel addresses to form lookup values which are used to determine the original pixel luma data.

23. The system as recited in claim 16 wherein the chrominance circuit comprises:
a chroma address sequencer for generating a chroma pixel index addresses based on the chroma data of the original image, and
an original sub-block chrominance buffer for receiving the chroma pixel index addresses and for generating resized pixel chroma data values based on the chroma pixel index addresses.

24. A method for resizing an original image into a resized image comprising the steps of:
dividing the original image into original sub-blocks having original borders;
changing the size of the original sub-blocks to form resized sub-blocks having resized borders based directly on the original borders; and
combining the resized sub-blocks to form the resized image.

25. The method as recited in claim 24 wherein the step of changing the size comprises the step of resizing centers of the original sub-blocks by interpolation.

26. The method as recited in claim 25 wherein the step of resizing centers comprises the step of using zero order interpolation.

27. The method as recited in claim 26 wherein the step of using zero order interpolation comprises the step of interpolating chrominance channels of the centers.

28. The method as recited in claim 27 wherein the step of changing the size comprises the step of resizing a luminance channel of the original image based on coefficients which are powers of two.

29. The method as recited in claim 28 wherein the step of resizing a luminance channel is performed without multipliers.

30. A method for resizing an original image into a resized image comprising the steps of:
processing original luma pixel data relating to the original image to form resized luma pixel data;
processing original chroma pixel data relating to the original image separate from the original luma pixel data to form resized chroma pixel data; and
forming the resized image based on the resized luma pixel data and the resized chroma pixel data.

31. The method as recited in claim 30 wherein the step of processing the original luma pixel data comprises the step of filtering the original luma pixel data.

32. The method as recited in claim 31 wherein the step of filtering comprises the step of finite-impulse-response filtering the original luma pixel data.

33. The method as recited in claim 32 wherein the step of processing original chroma pixel data comprises the step of interpolating the original chroma pixel data.

34. The method as recited in claim 33 wherein the step of processing original chroma pixel data comprises the step of first order interpolating the original chroma pixel data.
